(19) United States
(12) Patent Application Publication
(10) Pub. No.: US 2010/0141419 A1
(43) Pub. Date: Jun. 10, 2010

(54) Combined Backup Alarm and Reversing Lamp

(76) Inventor: Mark T. Coward, Schaumburg, IL (US)

Correspondence Address: BARNES & THORNBURG LLP, P.O. BOX 2786, CHICAGO, IL, 60690-2786, US

(21) Appl. No.: 12/630,961

(22) Filed: Dec. 4, 2009

Related U.S. Application Data
(60) Provisional application No. 61/119,882, filed on Dec. 4, 2008.

(51) Int. Cl. B60Q 1/50; H04R 1/20

(52) U.S. Cl. 340/464; 381/342

(57) ABSTRACT

A backup alarm that is adapted to be mounted to a motor vehicle. The backup alarm is activated when the motor vehicle is placed in a reverse gear. The backup alarm makes an audible tone to alert individuals of the motor vehicle's intended reverse travel. The alarm unit allows the vehicle to include a backup alarm and a reversing lamp in the same location, mounted to the vehicle. The lamp consists of an array of light emitting diodes LEDs arranged in a pattern at the face of the unit so as to provide clear illumination and serve as a reverse warning lamp. Also, in the same unit is a backup alarm.

The present application claims priority to U.S. Provisional Patent Application Ser. No. 61/119,882 filed on Dec. 04, 2008, which is herein incorporated by reference.

### BACKGROUND

The present disclosure relates to alarms, and particularly to alarms used in motor vehicles. More particularly, the present disclosure relates to a backup alarms used to alert individuals that a motor vehicle is reversing or preparing to reverse. In order to be effective, a vehicle backup (reversing) alarm needs to be mounted on the rear of the vehicle as close as feasible to the rear hazard zone, so as to provide a clear warning during reverse movement of the vehicle.

Many commercial vehicles use a standard size rubber grommet to hold their reverse warning lamps, some manufacturers have utilized this grommet to mount a backup alarm to the vehicle, however, this results in removal of one of the reversing lamps, reducing the night time illumination to the rear of the vehicle when reversing and also the ease of recognition of the reverse operation of the vehicle by other road users. The present disclosure relates to two backup alarm designs. One of which uses the existing rubber mounting grommet, the other uses the hole in the vehicle from which the grommet is removed.

### SUMMARY

According to the present disclosure, a backup alarm is an audible alarm adapted to be mounted to a motor vehicle. The backup alarm is activated when the motor vehicle is placed in a reverse gear. The backup alarm makes an audible tone to alert individuals of the motor vehicle's intended reverse travel.

In illustrative embodiments the alarm unit allows the vehicle to include a backup alarm and a reversing lamp in the same location, mounted through a standard lamp hole in the vehicle. The lamp consists of an array of white light emitting diodes LEDs arranged in a pattern at the face of the unit so as to provide clear illumination and serve as a reverse warning lamp. Also, in the same unit is a backup alarm.

Illustrative embodiments, the alarm unit is installed onto a vehicle by either removing the present reversing lamp and grommet or by cutting or stamping out a standard size hole in the vehicle's body or other external, flat surface. The lamp may be controlled so as to provide continuous output when powered or alternatively to flash in conjunction with the output pulse (beeps) of its audible backup alarm, so as to provide easier identification of the specific vehicle reversing. Also, the present disclosure provides for a more recognizable indication to hearing impaired persons.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1. is a perspective view of the rear portion of a truck showing the backup alarm units positioned between the vehicle tail lights;

FIG. 2 is a perspective view of a first embodiment of the backup alarm unit;

FIG. 3 is a cross sectional view taken along line 3-3 of FIG. 2 showing the alarm housing and a cover on the alarm housing containing a series of individual lights and also showing the transducer and control circuit board positioned within the housing;

FIG. 3a is an enlarged perspective view of the electrical connector of FIG. 3.

FIG. 4 is a perspective view of the cover of the backup alarm unit showing a centrally located grill and a series of radially spaced apart lights positioned around the grill;

FIG. 5 is a front view of the cover;

FIG. 6 is a rear view of the cover;

FIG. 7 is a perspective view of a second embodiment of the backup alarm;

FIG. 8 is a cross sectional view taken along line 8-8 of FIG. 7 showing a rear housing containing a transducer and a control board and further showing the outer horn coupled to the rear housing and an inverted inner horn having a series of lights;

FIG. 9 is a perspective view of the inverted inner horn showing the center portion containing a series of lights surrounded by a grill having a series of openings;

FIG. 10 is a front view of the inverted inner horn;

FIG. 11 is a rear view of the inverted inner horn;

FIG. 12 is a sectional view of a third embodiment showing the grill at the front of the alarm;

FIG. 13 is a perspective view of another embodiment of the backup alarm having a transparent lens cover and a series of lights positioned behind the lens or through the lens to create a back light and also showing a series of elongated slots formed around the perimeter of the alarm that form sound ports to transmit the sound of the alarm; and

FIG. 14 is a front elevational view of the alarm of FIG. 13.

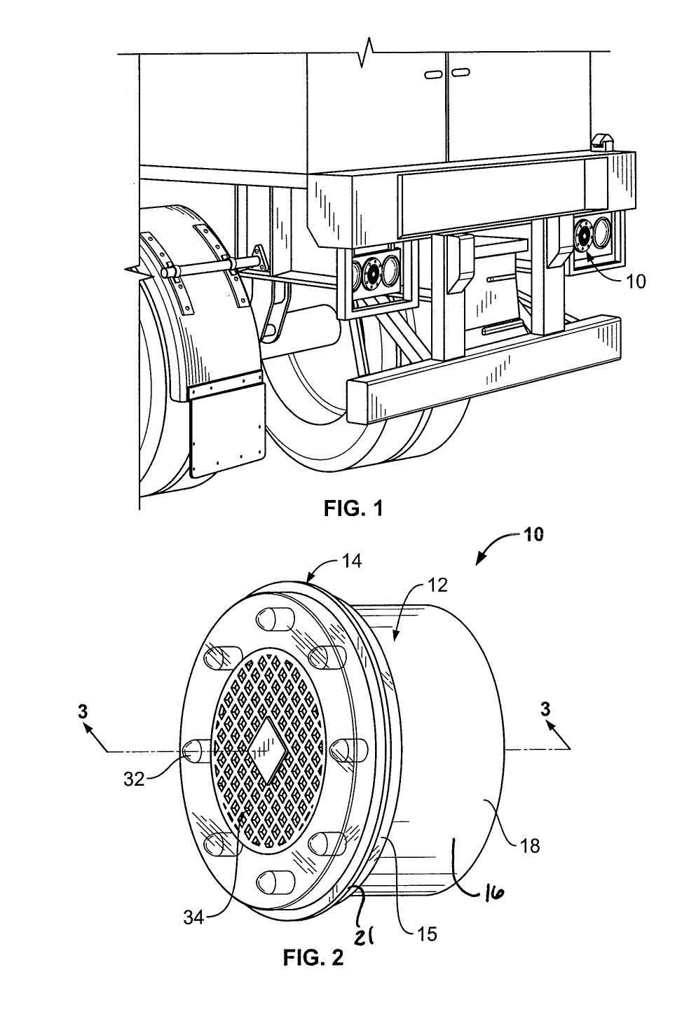

### DETAILED DESCRIPTION

While the present disclosure may be susceptible to embodiment in different forms, there are shown in the drawings, and herein will be described in detail, embodiments with the understanding that the present description is to be considered an exemplification of the principles of the disclosure and is not intended to limit the disclosure to the details of construction and the arrangements of components set forth in the follow description or illustrated in the drawings.

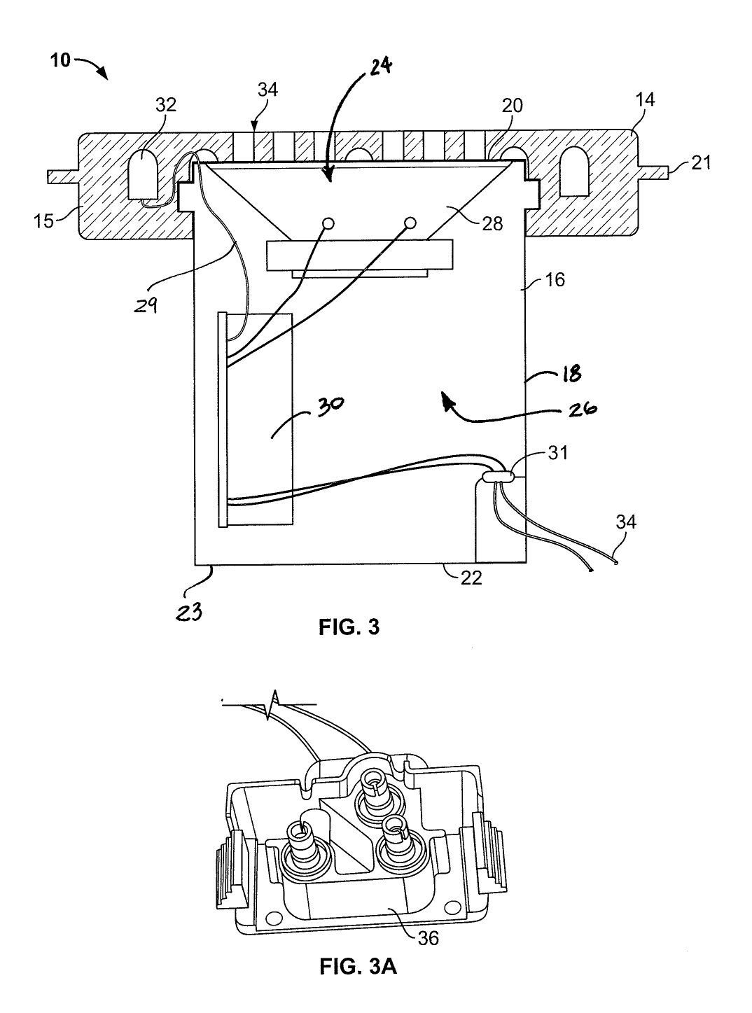

The alarm unit 10 includes a backup alarm 12 and cover 14 as shown in FIG. 2. The cover 14 includes a peripheral rim 21, which latches into the vehicle's lamp mounting grommet during installation. The cover 14 engages and locks onto the front of the backup alarm 12. The backup alarm 12 includes a housing 16 that includes an annular wall 18 as shown in FIG. 3. The housing 16 is open at a first end 20 and includes a bottom wall 22 at a second end 23. The first end 20 includes a mouth 24 opening receive the cover 14. The housing 16 includes a receiving chamber 26, that is configured to house a transducer 28, and a control circuit assembly 30.

The bottom wall 22 includes either a rubber grommet 31, which seals the power wires 34 to prevent moisture from entering the housing 16 or alternatively includes a molded connector 36 to allow for easy connection to the vehicles original backup lamp power plug, as shown, for example, in FIG. 3A.

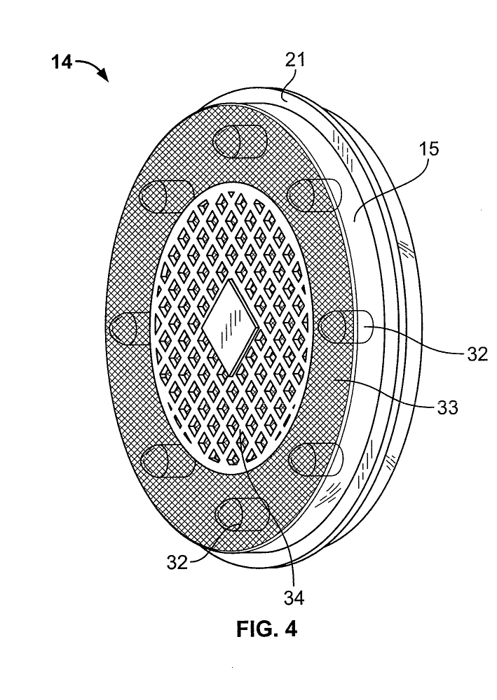

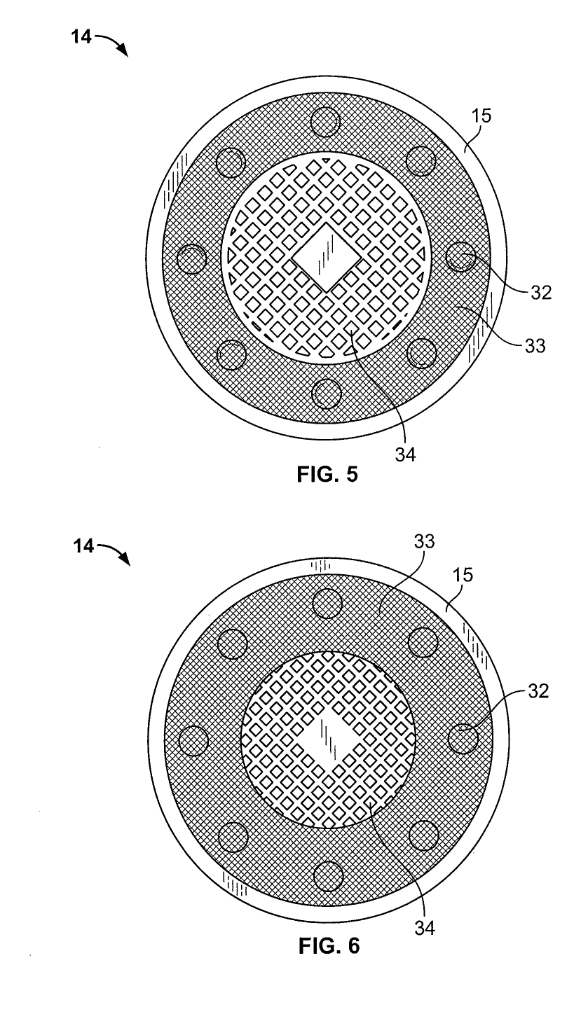

The cover 14 includes a disk shaped housing 15, which may be made of a colored, opaque or clear material such as nylon, ABS plastic or polycarbonate as shown in FIG. 4. The cover 14 may also be designed to have a multi-faceted (Prismatic) surface 33, or have a reflective surface film applied to it so as to reflect light directed toward it from headlamps of vehicles at night.

The housing 15, contains an array of white Light Emitting Diodes (LEDs) 32 and a grille 34 which allows sound from the transducer 28 to pass through the cover 14 as shown in FIG. 4. The LEDs 32 are either molded into the cover or are inserted into individual openings formed in the cover 14. The array of LEDs is electrically connected together culminating with a short pair of power wires 29 as shown in FIG. 3. The power wires 29 are routed past the transducer 28 and into the housing 16 where they are soldered or plugged onto the control circuit assembly 30.

The cover 14 is twist locked or threaded and may be permanently glued or sonic welded onto the mouth 24 of the housing 16 as shown in FIG. 3. The Transducer 28 is connected to, and powered by, electronic circuitry on the control circuit assembly 30, which causes the transducer 28 to oscillate and output a high sound pressure audible sound signal. The transducer 28 may be a speaker or piezo, or other type of sound producing element that is capable of converting an electrical signal into audible sound.

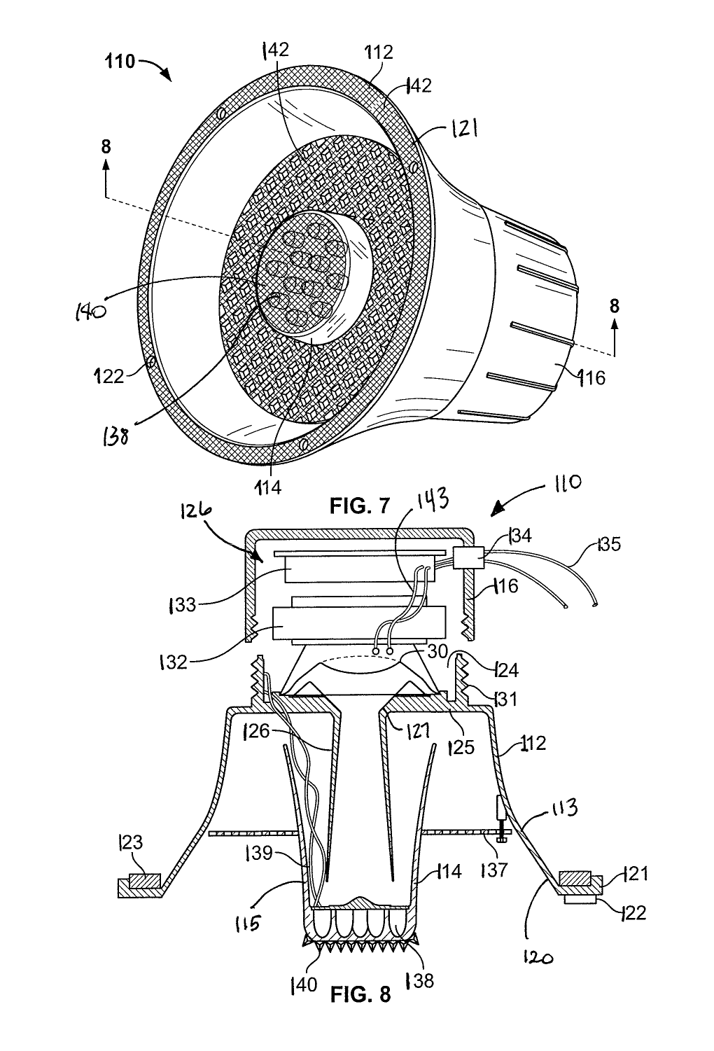

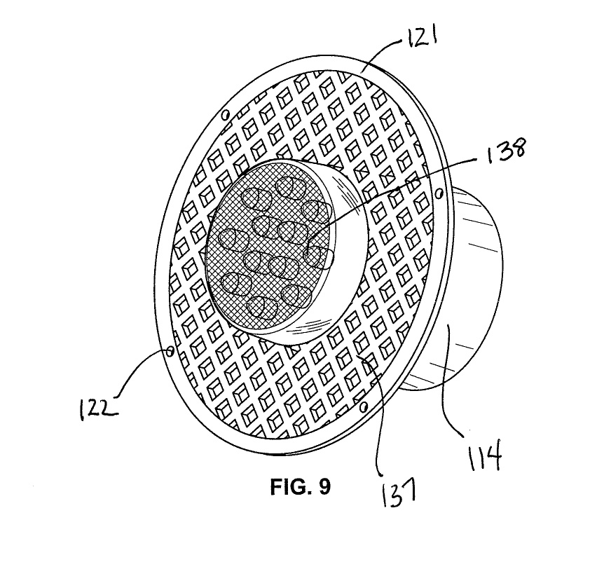

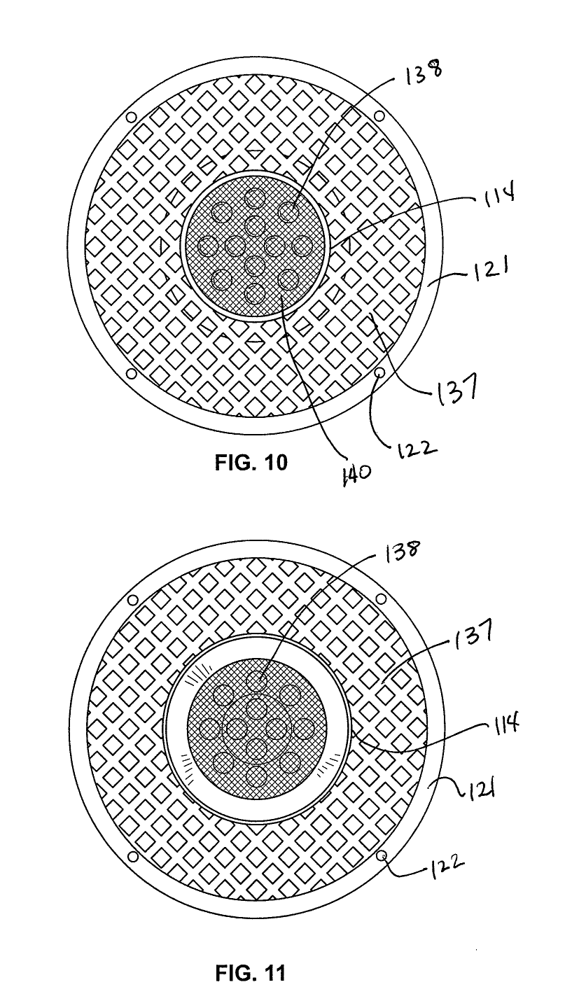

In a second embodiment, the alarm unit 110 includes a horn 112, nose cone assembly 114 and rear cap 116 as shown in FIG. 7. The horn 112 includes a peripheral rim 121, which prevents the alarm unit 110 from falling through the mounting hole in the vehicle. The peripheral rim 121, includes radially spaced reinforced holes 122, to be used for mounting to the vehicle. The rear of the peripheral rim 121, includes a gasket 123 made of rubber, nylon, neoprene or ABS to create a weathertight seal between the alarm unit 110 and the mounting surface of the vehicle, as shown in FIG. 8.

The alarm unit 110 includes a horn 112 that is open at a first end 120 and includes a bottom wall 125 which separates the horn 112 from second end 124 as shown in FIG. 8. The first end 120 includes a mouth opening. The horn consists of a tapered annular wall 113 which is mathematically dimensioned so as to form the third segment of a three segment dual reflex horn.

The second end 124 includes the rear side of wall 125 which is profiled so as to create a tapered Cone Plug 127, the cone plug fits into the space formed by the speaker cone 130 as shown in FIG. 8. The second end 124 has a surrounding circular wall 131 which is externally threaded.

The bottom wall 125 includes a centrally positioned horn tube 126 projecting forward. The horn tube 126 has a tapered annular wall which is mathematically dimensioned so as to form the first segment of a three-segment dual reflex horn. The rear cap 16 includes a receiving chamber 126 that is configured to house a transducer 132, and a control circuit assembly 133.

The rear cap 116 includes either a rubber grommet 134, which seals the power wires 135 to prevent moisture from entering the rear cap 116 to allow for easy connection to the vehicles original backup lamp power plug.

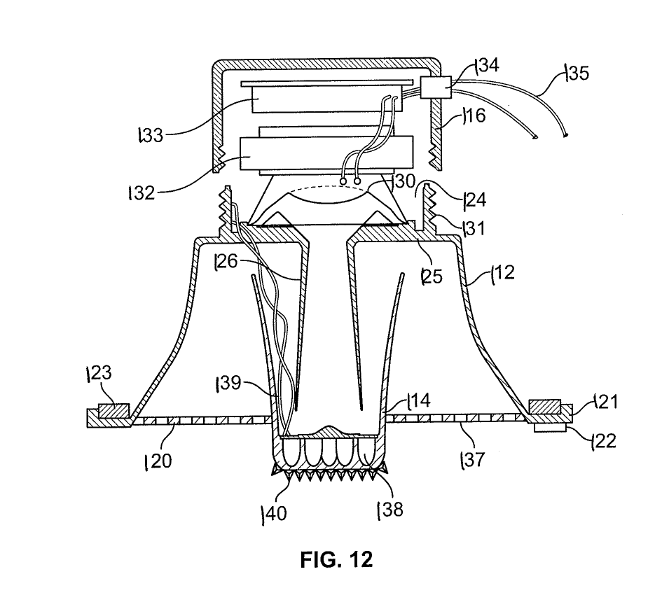

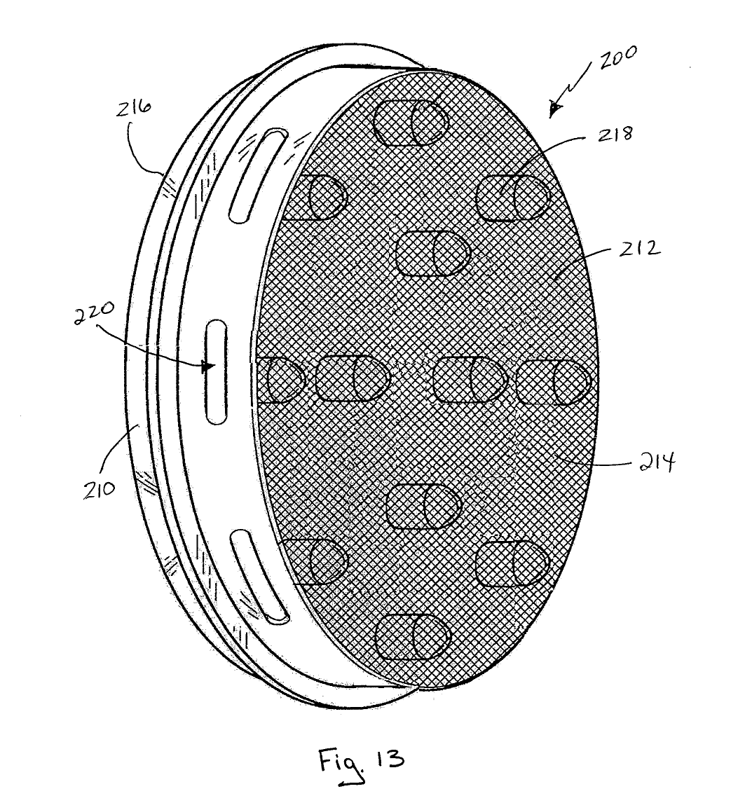

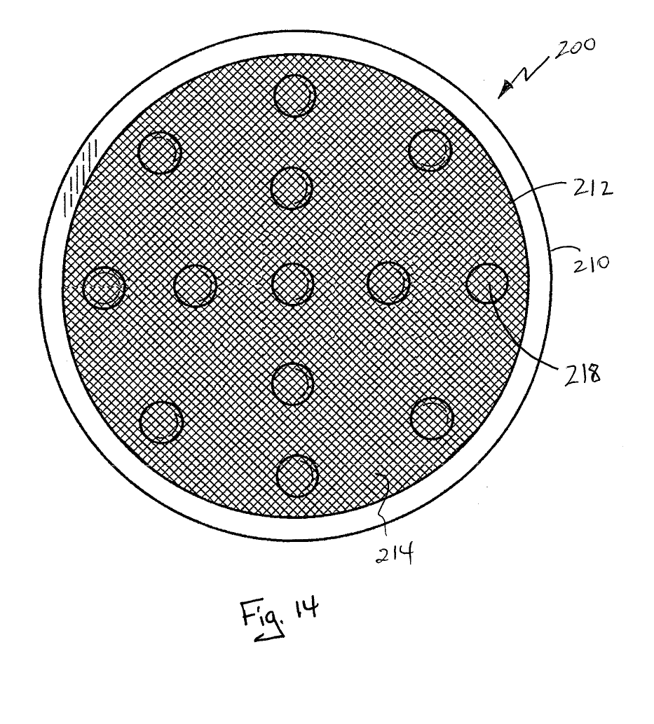

The nose cone assembly 114 consists of a tapered annular wall 115 which is mathematically dimensioned so as to form the second segment of a three segment dual reflex horn. The nose cone assembly 114 also includes a molded grill 137 positioned midway along its outer wall. The grill 137 allows sound to pass through but prevents foreign objects from entering the inner structure of the alarm unit. Alternatively the grill 137 can be positioned farther forward as shown in FIG. 12. The surface or details of the grill 137 may also be designed to have multi-faceted (Prismatic) surfaces 142, so as to reflect light directed toward it from headlamps of vehicles at night as shown in FIG. 7.

The closed end of the nose cone assembly 114 contains an array of white Light Emitting Diodes (LEDs) 138; these are either molded into the nose cone 114, or are inserted into individual openings formed in the nose cone 114. The array of LEDs is electrically connected together culminating with a short pair of power wires 139. The power wires 139 are routed through the bottom wall 125 where they are soldered or plugged onto the control circuit assembly 133. The LEDs are controlled by the power circuit assembly 133 and may be controlled so as to provide continuous light output when powered or alternatively to flash in conjunction with the sound output pulses (beeps) of its audible backup alarm, so as to provide easier identification of the specific vehicle reversing.

The nose cone assembly may be made of a colored, opaque or clear material such as nylon, ABS plastic or polycarbonate. The surface may also be designed to have a multi-faceted (Prismatic) surface 140, so as to reflect light directed toward it from headlamps of vehicles at night.

The rear cap 116 is twist locked or threaded and may be permanently glued or sonic welded onto the circular wall 131. The Transducer 132 is attached to the bottom wall and positioned so as to project sound energy into the horn tube 126. The transducer 132 is connected to, and powered by, electronic circuitry on the control circuit assembly 133, which causes the speaker 132 to oscillate and output a high sound pressure audible sound signal.

The application of electrical power to the power wires 135 powers the electronic circuit assembly 133 to oscillate and the output signal is conducted to the speaker 132 via the signal wires 143 as shown in FIG. 8. The speaker converts the electrical signal into a high power audio signal which travels along the horn tube 126 gradually expanding as the dimensions of the sound tube expand, the sound strikes the inside of the nose cone 114 and follows the contour to change direction 180 degrees continuing to expand as the inner wall of the nose cone 114 increases in size. The sound strikes the bottom wall 125 and follows the contour of the wall 125 then enters the horn 112, the sound pressure waves expand as the diameter of the horn increases, the sound passes through grill 137 and finally exits the alarm as a greatly amplified sound.

In another embodiment, an alarm unit 200 includes a housing 210 and a lens cover 212 coupled to the housing 210. The housing 210 of the alarm unit 200 is adapted to be coupled to a motor vehicle. The housing 210 includes a front side 214 and a spaced apart rear side 216. The alarm unit includes a sound transmitter positioned within the housing 210 the sound transmitter configured to emit an audible sound when the motor vehicle is in reverse. The lens cover 212 is coupled to the housing 210 and is positioned to lie near the front side 214 of the housing 210.

The alarm unit 200 includes a series of lighting elements 218 that are configured to project light through the lens cover 212. The lighting elements (light emitters) 218 are configured to be illuminated when the motor vehicle is in reverse as they are wired into the backup lights of the motor vehicle. The alarm unit includes openings 220 positioned near the front side 214 of the housing 210. The openings 220 are configured to permit sound from the sound transmitter to exit the alarm unit 200 to alert people that the motor vehicle is in reverse. The openings 220, in the illustrative embodiment, are elliptical in shape and are positioned around the outer perimeter of the alarm unit 200.

While embodiments have been illustrated and described in the drawings and foregoing description, such illustrations and description are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as constraining or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure and the appended claims.

What is claimed is:

1. A motor vehicle backup alarm comprising:
a housing adapted to be coupled to a motor vehicle, the housing having a front side, a rear side and at least one side wall positioned between the front and rear sides;
a sound transmitter positioned within the housing, the sound transmitter configured to emit an audible sound when the motor vehicle is in reverse;
a lens cover coupled to the housing and positioned to lie near the front side of the housing;
at least one lighting element configured to project light through the lens cover, the lighting element being illuminated when the motor vehicle is in reverse;
at least one opening positioned near the front side of the housing and configured to permit sound from the sound transmitter to exit the motor vehicle backup alarm to alert people that the motor vehicle is in reverse.

2. The motor vehicle backup alarm of claim 1, wherein alarm includes a reflective surface.

3. The motor vehicle backup alarm of claim 2, wherein the sound transmitter is in the form of a speaker that is configured to generate the audible sound when the motor vehicle is in reverse.

4. The motor vehicle backup alarm of claim 1, wherein the lighting element includes a series of light emitting diodes that are configured to emit light when the motor vehicle is in reverse.

5. The motor vehicle backup alarm of claim 1, wherein the alarm includes a peripheral rim that is used to secure the alarm to the motor vehicle.

6. The motor vehicle backup alarm of claim 5, further including a grommet that is configured to be coupled to the peripheral rim to secure the backup alarm to an opening formed in the motor vehicle.

7. The motor vehicle backup alarm of claim 1, wherein the at least one opening is centrally located at the front side of the housing and the lens cover is positioned around the at least one opening.

8. The motor vehicle backup alarm of claim 1, wherein the lens cover is centrally located at the front side of the housing and the at least one opening is positioned around at least a portion of the lens cover.

9. The motor vehicle backup alarm of claim 1, wherein the sound transmitter includes a horn having a tapered annular wall that forms the third segment of a three segment dual reflex horn.

10. A motor vehicle backup alarm comprising:
a housing adapted to be coupled to a motor vehicle, the housing having a front side, a rear side;
a sound transmitter positioned within the housing, the sound transmitter configured to emit an audible sound when the motor vehicle is in reverse;
a series of light emitters configured to project light a the rear side of the housing, the light emitters configured to be illuminated when the motor vehicle is in reverse;
a sound passageway positioned near the front side of the housing and configured to permit sound from the sound transmitter to be transmitted from the motor vehicle backup alarm to alert people that the motor vehicle is in reverse.

11. The motor vehicle backup alarm of claim 10, wherein alarm includes a reflective surface.

12. The motor vehicle backup alarm of claim 11, wherein the sound transmitter is in the form of a speaker configured to generate the audible sound when the motor vehicle is in reverse.

13. The motor vehicle backup alarm of claim 10, wherein the light emitters are in the form of light emitting diodes that are configured to emit light when the motor vehicle is in reverse.

14. The motor vehicle backup alarm of claim 10, wherein the alarm includes a peripheral rim that is used to secure the alarm to the motor vehicle.

15. The motor vehicle backup alarm of claim 14, further including a grommet that is configured to be coupled to the peripheral rim to secure the backup alarm to an opening formed in the motor vehicle.

16. The motor vehicle backup alarm of claim 10, wherein the sound passageway is centrally located at the front side of the housing and the light emitters are positioned around the sound passageway.

17. The motor vehicle backup alarm of claim 10, wherein the light emitters are centrally located at the front side of the housing and the sound passageway is positioned around at least a portion of the light emitting diodes.

18. The motor vehicle backup alarm of claim 10, wherein the sound transmitter includes a horn having a tapered annular wall that forms the third segment of a three segment dual reflex horn.
